(19) United States
(12) Patent Application Publication
(10) Pub. No.: US 2026/0196607 A1
(43) Pub. Date: Jul. 9, 2026

(54) REINFORCEMENT STRUCTURES FOR THERMAL BARRIERS

(71) Applicant: ASPEN AEROGELS, INC., Northborough, MA (US)

(72) Inventors: Younggyu Nam, Northborough, MA (US); Lixin Wang, Northborough, MA (US); Christopher Stow, Northborough, MA (US)

(21) Appl. No.: 19/134,724

(22) PCT Filed: Mar. 1, 2024
(86) PCT No.: PCT/US2024/018174

§ 371 Date: May 31, 2025

Related U.S. Application Data
(60) Provisional application No. 63/488,347, filed on Mar. 3, 2023.

(51) Int. Cl. H01M 10/658; H01M 10/651

(52) U.S. Cl. CPC H01M 10/658; H01M 10/651

(57) ABSTRACT

Various embodiments disclosed relate to a structural feature in a thermal barrier. The present disclosure includes a. battery module having a stack of battery cells located within a module housing and a thermal barrier comprising an aerogel between at least two cells in the stack of battery cells. The thermal barrier can include an isolation layer having a major plane. The structural feature can be distributed in the isolation layer. The structural feature can include a plurality of elements, each of the plurality of elements extending at least partially through the major plane.

### CLAIM OF PRIORITY

This application claims the benefit of priority to U.S. Provisional Patent Application Serial No. 63/488,347, filed on Mar. 3, 2023, which is incorporated by reference herein in its entirety

### TECHNICAL FIELD

The present disclosure relates generally to materials and systems and methods for preventing or mitigating thermal events, such as thermal runaway issues, in energy storage systems. In particular, the present disclosure provides thermal barrier materials. The present disclosure further relates to a battery module or pack with one or more battery cells that includes the thermal barrier materials, as well as systems including those battery modules or packs. Aspects described generally may include aerogel materials.

### BACKGROUND

Lithium-ion batteries (LIBs) are widely used in powering portable electronic devices such as cell phones, tablets, laptops, power tools and other high-current devices such as electric vehicles because of their high working voltage, low memory effects, and high energy density compared to traditional batteries. However, safety is a concern as LIBs are susceptible to catastrophic failure under “abuse conditions” such as when a rechargeable battery is overcharged, over-discharged, operated at or exposed to high temperature and high pressure.

To prevent cascading thermal runaway events from occurring, there is a need for effective insulation and heat dissipation strategies to address these and other technical challenges of LEBs.

### SUMMARY OF THE DISCLOSURE

In an aspect, a battery module includes a stack of battery cells located within a module housing; and a thermal barrier comprising an aerogel between at least two cells in the stack of battery cells, the thermal barrier including an isolation layer and a structural feature distributed in the isolation layer.

In an aspect, a thermal barrier for use in a battery module can include an isolation layer comprising an aerogel, the isolation layer configured to thermally isolate individual battery cells within the battery module; and a structural feature distributed within the isolation layer.

In an aspect, a method of making a structural feature in a thermal barrier comprising an aerogel can include removing a portion of the aerogel to form one or more cavities; and forming the structural feature in the one or more cavities.

In an aspect, a method of making a structural feature in a thermal barrier comprising an aerogel can include forming the structural feature and inserting the aerogel in and around the structural feature.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1A-1B illustrate a battery module in an example.

FIGS. 2A-2B depict an example structural feature for use in a thermal barrier.

FIGS. 3A-3C depict an example structural feature in a thermal barrier made of an aerogel in an example.

FIGS. 4A-4C depict an example structural feature.

FIGS. 5A-5C depict an example structural feature in a thermal barrier with an aerogel and an encapsulation.

FIGS. 6A-6D depict a structural feature in a thermal barrier with an aerogel in an example.

FIGS. 7A-7B illustrate an example thermal barrier structural feature with aerogel.

FIGS. 8A-8D illustrate an example thermal barrier with a structural feature and an aerogel.

FIGS. 9A-9F illustrate a thermal barrier with a structural feature having encapsulation in an example.

FIGS. 10A-10D illustrate a structural feature made of a three-dimensional web in an example. FIGS. 10A-10D illustrate a structural feature made of a three-dimensional web.

FIGS. 11A-11B illustrate an example structural feature for a thermal barrier with an aerogel.

FIGS. 12A-12D illustrate an example structural feature with aerogel.

FIGS. 13A-13B illustrate an example structural feature with an aerogel.

FIG. 14 illustrates a flow chart of a method of making a thermal barrier in an example.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The present disclosure describes, among other things, systems and methods related to thermal barrier for battery modules. The thermal barriers can be aerogel-based thermal barriers, such as for within or around battery modules. Discussed herein, among other things, is the creation and use of a structural feature within such thermal barriers to impart shear strength and compressibility to the thermal barriers.

Thermal barriers, which can include thermally insulative layers and structures, can be used in battery modules to help regulate temperature and heat flow within such battery modules. In one aspect, lithium-ion batteries, often used in a stack of many battery cells, can benefit from thermal regulation to prevent thermal runaway, which could cause potential fires, overheating, combustion, or other issues associated with high temperatures in such a battery module.

Such thermal barriers can be made of thermal insulation materials (such as isolation, isolating, insulation, or insulating materials or layers) as discussed in detail below, such as aerogel materials. These materials, while providing thermal benefits, can suffer from mechanical stress, such as during the charge and discharge process within a battery cell stack. In this case, a high amount of shear stress can exist between the thermal barrier and adjacent battery cells, can be imparted onto the thermal barrier. The shear stress can prevent the thermal barrier from slipping away from between two battery cells. Moreover, the materials from which thermal barriers are made may not have the desired compressibility for large battery stacks. Improved compressibility can be desired to accommodate the battery volume expansion and contraction during the charge and discharge process.

For this reason, discussed herein is the use of structural features within thermal barriers. The structural features can be inserted into and around the aerogel of the thermal barriers to impart shear strength and compressibility. The structural features can, in one aspect, include dots, rods, tubes, lattices, nets, ribbons, frames, or other appropriate shapes that support the structural integrity of the aerogel. These structural features can be, in one aspect, created first, and the aerogel inserted there around. Or these structural features can be formed within an already formed aerogel.

The structural features can include materials selected from a non-limiting list of foam, elastomers, thermoplastics, cross-linked polymers, amorphous and/or crystalline polymers, polymer or plastic materials, or dielectric materials, in one aspect, polyimides, polycarbonates, polyester, glass fibers, or other appropriate materials with appropriate electrical and thermal properties. Each material has its own compressibility. The shear force and compressibility of the thermal barrier can be adjusted by choosing structural features of different materials.

The thermal barrier insulation materials, as described in aspects below, can be used as a single heat resistant layer, or in combination with other layers that provide additional function to a multilayer configuration, such as mechanical strength, compressibility, heat dissipation/conduction, etc. Insulation layers described herein are responsible for reliably containing and controlling heat flow from heat-generating parts in small spaces and to provide safety and prevention of fire propagation for such products in the fields of electronic, industrial, and automotive technologies.

In many embodiments of the present disclosure, the insulation layer functions as a flame/fire deflector layer either by itself or in combination with other materials that enhance performance of containing and controlling beat flow. In one aspect, the insulation layer may itself be resistant to flame and/or hot gases and further include entrained particulate materials that modify or enhance heat containment and control.

An insulation layer can include any kind of insulation layer commonly used to separate battery cells or battery modules. Exemplary insulation layers include, but are not limited to, polymer based thermal barriers (e.g., polypropylene, polyester, polyimide, and aromatic polyamide (aramid)), phase change materials, thermal capacitive materials, intumescent materials, aerogel materials, mineral based barrier (e.g., mica), and inorganic thermal barriers (e.g., fiberglass containing barriers).

One example of a highly effective insulation layer includes an aerogel. Aerogels describe a class of material based upon their structure, namely low density, open cell structures, large surface areas (often 900 m²/g or higher) and sub nanometer scale pore sizes. The pores may be filled with gases such as air. Aerogels can be distinguished from other porous materials by their physical and structural properties. Although an aerogel material is an exemplary insulation material, the invention is not so limited. Other thermal insulation material layers may also be used in examples of the present disclosure.

Selected examples of aerogel formation and properties are described. In several examples, a precursor material is gelled to form a network of pores that are filled with solvent. The solvent is then extracted, leaving behind a porous matrix. A variety of different aerogel compositions are known, and they may be inorganic, organic, and inorganic/organic hybrid. Inorganic aerogels are generally based upon metal alkoxides and include materials such as silica, zirconia, alumina, and other oxides. Organic aerogels include, but are not limited to, urethane aerogels, resorcinol formaldehyde aerogels, and polyimide aerogels.

Inorganic aerogels may be formed from metal oxide or metal alkoxide materials. The metal oxide or metal alkoxide materials may be based on oxides or alkoxides of any metal that can form oxides. Such metals include, but are not limited to silicon, aluminum, titanium, zirconium, hafnium, yttrium, vanadium, cerium, and the like. Inorganic silica aerogels are traditionally made via the hydrolysis and condensation of silica-based alkoxides (such as tetraethoxylsilane), or via gelation of silicic acid or water glass. Other relevant inorganic precursor materials for silica based aerogel synthesis include, but are not limited to metal silicates such as sodium silicate or potassium silicate, alkoxysilanes, partially hydrolyzed alkoxysilanes, tetraethoxylsilane (TEOS), partially hydrolyzed TEOS, condensed polymers of TEOS, tetramethoxylsilane (TMOS), partially hydrolyzed TMOS, condensed polymers of TMOS, tetra-n-propoxysilane, partially hydrolyzed and/or condensed polymers of tetra-n-propoxysilane, polyethylsilicates, partially hydrolyzed polyethysilicates, monomeric alkylalkoxy silanes, bis-trialkoxy alkyl or aryl silanes, polyhedral silsesquioxanes, or combinations thereof.

In certain embodiments of the present disclosure, pre-hydrolyzed TEOS, such as Silbond H-5 (SBH5, Silbond Corp), which is hydrolyzed with a water/silica ratio of about 1.9-2, may be used as commercially available or may be further hydrolyzed prior to incorporation into the gelling process. Partially hydrolyzed TEOS or TMOS, such as polyethysilicate (Silbond 40) or polymethylsilicate may also be used as commercially available or may be further hydrolyzed prior to incorporation into the gelling process.

Inorganic aerogels can also include gel precursors comprising at least one hydrophobic group, such as alkyl metal alkoxides, cycloalkyl metal alkoxides, and aryl metal alkoxides, which can impart or improve certain properties in the gel such as stability and hydrophobicity. Inorganic silica aerogels can specifically include hydrophobic precursors such as alkylsilanes or arylsilanes. Hydrophobic gel precursors may be used as primary precursor materials to form the framework of a gel material. However, hydrophobic gel precursors are more commonly used as co-precursors in combination with simple metal alkoxides in the formation of amalgam aerogels. Hydrophobic inorganic precursor materials for silica based aerogel synthesis include, but are not limited to trimethyl methoxysilane (TMS), dimethyl dimethoxysilane (DMS), methyl trimethoxysilane (MTMS), trimethyl ethoxysilane, dimethyl diethoxysilane (DMDS), methyl triethoxysilane (MTES), ethyl triethoxysilane (ETES), diethyl diethoxysilane, dimethyl diethoxysilane (DMDES), ethyl triethoxysilane, propyl trimethoxysilane, propyl triethoxysilane, phenyl trimethoxysilane, phenyl triethoxysilane (PhTES), hexamethyldisilazane and hexaethyldisilazane, and the like. Any derivatives of any of the above precursors may be used and specifically certain polymeric of other chemical groups may be added or cross-linked to one or more of the above precursors.

Organic aerogels are generally formed from carbon-based polymeric precursors. Such polymeric materials include, but are not limited to resorcinol formaldehydes (RF), polyimide, polyacrylate, polymethyl methacrylate, acrylate oligomers, polyoxyalkylene, polyurethane, polyphenol, polybutadiane, trialkoxysilyl-terminated polydimethylsiloxane, polystyrene, polyacrylonitrile, polyfurfural, melamine-formaldehyde, cresol formaldehyde, phenol-furfural, polyether, polyol, polyisocyanate, polyhydroxybenze, polyvinyl alcohol dialdehyde, polycyanurates, polyacrylamides, various epoxies, agar, agarose, chitosan, and combinations thereof. As one example, organic RF aerogels are typically made from the sol-gel polymerization of resorcinol or melamine with formaldehyde under alkaline conditions.

Organic/inorganic hybrid aerogels are mainly comprised of (organically modified silica (“ormosil”) aerogels. These ormosil materials include organic components that are covalently bonded to a silica network. Ormosils are typically formed through the hydrolysis and condensation of organically modified silanes, R—Si(OX)₃, with traditional alkoxide precursors, Y(OX)₄. In these formulas, X may represent, for example, CH₃, C₂H₅, C₃H₇, C₄H₉; Y may represent, for example, Si, Ti, Zr, or Al; and R may be any organic fragment such as methyl, ethyl, propyl, butyl, isopropyl, methacrylate, acrylate, vinyl, epoxide, and the like. The organic components in ormosil aerogel may also be dispersed throughout or chemically bonded to the silica network.

Aerogels can be formed from flexible gel precursors. Various flexible layers, including flexible fiber-reinforced aerogels, can be readily combined, and shaped to give pre-forms that when mechanically compressed along one or more axes, give compressively strong bodies along any of those axes.

One method of aerogel formation includes batch casting. Batch casting includes catalyzing one entire volume of sol to induce gelation simultaneously throughout that volume. Gel-forming techniques include adjusting the pH- and/or temperature of a dilute metal oxide sol to a point where gelation occurs. Suitable materials for forming inorganic aerogels include oxides of most of the metals that can form oxides, such as silicon, aluminum, titanium, zirconium, hafnium, yttrium, vanadium, and the like. Particularly preferred are gels formed primarily from alcohol solutions of hydrolyzed silicate esters due to their ready availability and low cost (alcogel). Organic aerogels can also be made from melamine formaldehydes, resorcinol formaldehydes, and the like.

As noted above, an aerogel may be organic, inorganic, or a mixture thereof. In some aspects, the aerogel includes a silica-based aerogel.

In one example, aerogel materials may be monolithic, or continuous throughout a structure or layer. In other examples, an aerogel material may include a composite aerogel material with aerogel particles that are mixed with a binder. Other additives may be included in a composite aerogel material, including, but not limited to, surfactants that aid in dispersion of aerogel particles within a binder. A composite aerogel slurry may be applied to a supporting plate such as a mesh, felt, web, etc. and then dried to form a composite aerogel structure.

One or more layers in a thermal barrier may include a reinforcement material. The reinforcing material may be any material that provides resilience, conformability, or structural stability to the aerogel material. Aspects of reinforcing materials include, but are not limited to, open-cell macroporous framework reinforcement materials, closed-cell macroporous framework reinforcement materials, open-cell membranes, honeycomb reinforcement materials, polymeric reinforcement materials, and fiber reinforcement materials such as discrete fibers, woven materials, non-woven materials, needled non-wovens, battings, webs, mats, and felts.

The reinforcement material in the thermal barrier can be selected from organic polymer-based fibers, inorganic fibers, carbon-based fibers, or a combination thereof. The inorganic fibers are selected from glass fibers, rock fibers, metal fibers, boron fibers, ceramic fibers, basalt fibers, or combination thereof. In some examples, the reinforcement material can include a reinforcement including a plurality of layers of material.

In addition to thermal insulating layers, the thermal barrier may further include thermal conductive layers. The thermally conductive layers in combination with thermal insulating layers are effective at channeling unwanted heat to a desired external location, such as external heat dissipating fins, a heat dissipating housing, or other external structure to dissipate unwanted heat to outside ambient air. In one example, a thermally conductive layer or layers helps to dissipate heat away from a localized beat load within a battery module or pack. Examples of high thermal conductivity materials include carbon fiber, graphite, silicon carbide, metals including but not limited to copper, stainless steel, aluminum, and the like, as well as combinations thereof.

To aid in the distribution and removal of heat by, in at least one embodiment the thermally conductive layer is coupled to a heat sink. It will be appreciated that there are a variety of heat sink types and configurations, as well as different techniques for coupling the heat sink to the thermally conductive layer, and that the present disclosure is not limited to the use of any one type of heat sink/coupling technique. For example, at least one thermally conductive layer of the multilayer materials disclosed herein can be in thermal communication with an element of a cooling system of a battery module or pack, such as a cooling plate or cooling channel of the cooling system. For another example, at least one thermally conductive layer of the multilayer materials disclosed herein can be in thermal communication with other elements of the battery pack, battery module, or battery system that can function as a heat sink, such as the walls of the pack, module, or system, or with other ones of the multilayer materials disposed between battery cells. Thermal communication between the thermally conductive layer of the multilayer materials and heat sink elements within the battery system can allow for removal of excess heat from the cell or cells adjacent to the multilayer material to the heat sink, thereby reducing the effect, severity, or propagation of a thermal event that may generate excess heat.

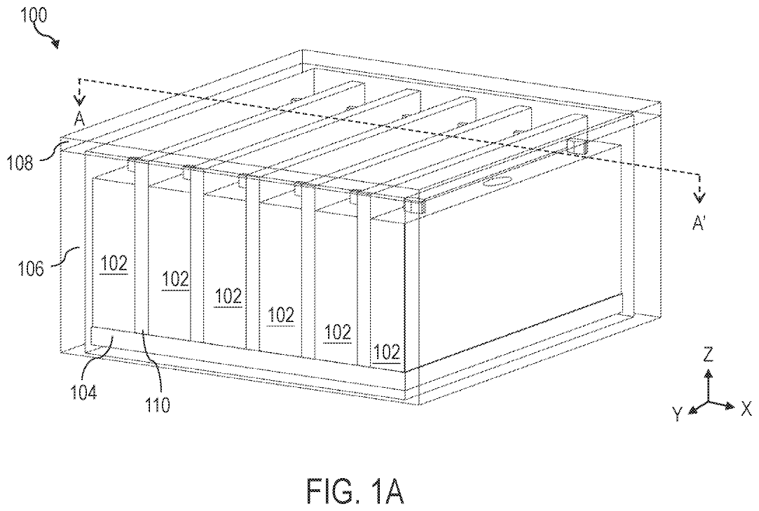

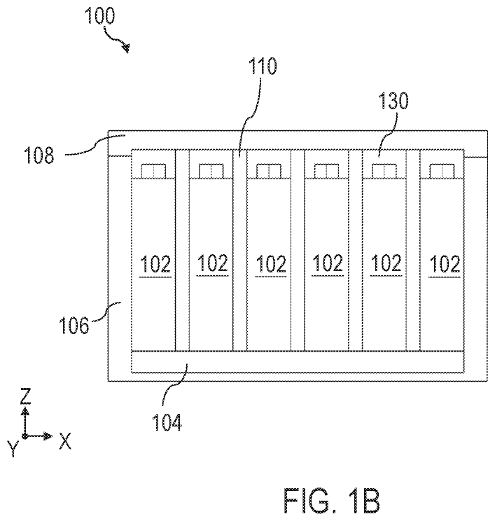

FIGS. 1A-1B illustrate a battery module 100 in an example. FIG. 1A shows one example of a battery module 100. The module 100 includes a stack of battery cells 101. In one aspect, the stack of cells 101 includes lithium-ion cells 102. Several configurations of lithium-ion cells 102 are possible. In one example, the stack of lithium-ion cells 102 includes lithium-ion pouch cells, although the invention is not so limited. A heat sink 104 is shown located on a side of the module 100, and in thermal communication with the battery cells 102. In the example of FIG. 1A, the stack of battery cells 102 are located within a module housing 106. A module cover 108 is further shown enclosing the stack of battery cells 102 within the module housing 106.

Thermal barriers 110 are shown between at least two cells in the stack of battery cells 102. In the example of FIG. 1A, a thermal barrier 110 is included between each cell in the stack of battery cells 102, although the invention is not so limited. In one aspect, groups of cells 102 are separated by thermal barriers 110. Inclusion of thermal barriers 110 provides a level of increased safety in the event of a thermal runaway in one or more of the cells 102. If a thermal runaway event occurs, a region affected by destruction of a failed cell 102 is contained to a region between thermal barriers 110 and/or the module housing 106. Improved thermal barriers 110 are desired to better isolate and protect adjacent regions within a battery module 100, especially in the event of thermal runaway in one or more individual cells 102.

A heat sink 104 is shown in FIG. 1A. Examples of heat sinks 104 include, but are not limited to, passive heat sinks such as metal plates, and active heat sinks such as fluid recirculation systems that remove heat to a remote location. In the example of FIG. 1A, thermal barriers 110 interlock with the heat sink within a slot or other recess. In one aspect, the heat sink 104 is a separate component contained within the module housing 106. In one aspect, the heat sink 104 is integral with a bottom surface of the module housing 106.

FIG. 1B shows a cross section view of the battery module 100 from FIG. 1A cutting along line AA′. At least some of the cells 102 are separated by thermal barriers 110. A space 130 is shown above the cells 102 within the module housing 106 and the module cover 108. In one aspect cells 102 can include a vent that directs gasses into the space 130. In the event of a thermal runaway, the thermal runaway ejecta can vent into the space 130 above a cell 102. In such an event, it is desirable to contain the hot thermal runaway ejecta and keep them from affecting adjacent cells 102. The thermal barriers 110 can contain the thermal runaway ejecta within space 130 and prevent the thermal runaway ejecta from affecting adjacent battery cells 102.

The battery module 100 of FIGS. 1A and 1B, can in one aspect, include thermal barriers 110 with one or more structural features integrated into the thermal barriers. These structural features can be integrated into the thermal barriers in various configurations, as described below.

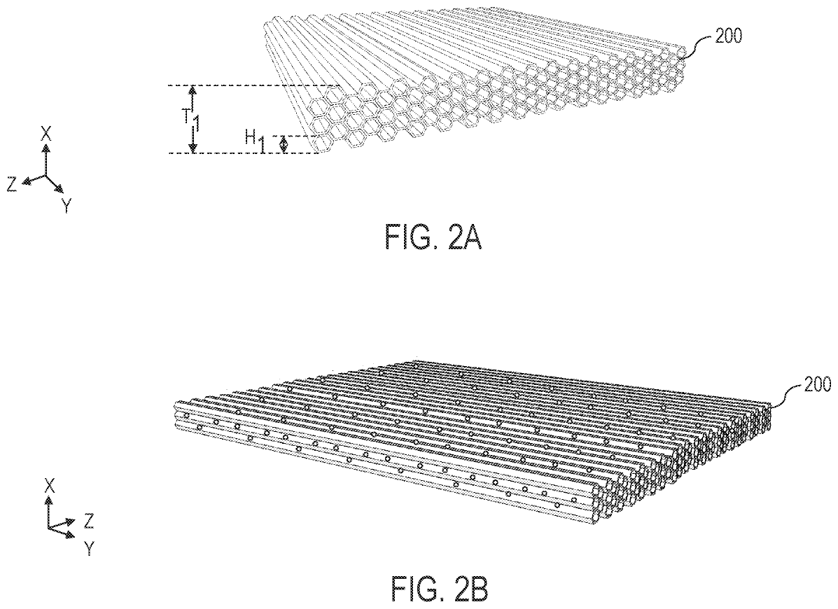

FIGS. 2A-2B depict an example structural feature 200 for use in a thermal barrier. FIG. 2A and FIG. 2B depict different perspective views of the structural feature 200. The structural feature 200 can include, in one aspect, a group of tubes along length or width directions of the thermal barrier as a reinforcement material. In one aspect, the reinforcement material can be used as a substitute for fibrous batting such as glass fibers, polymer fibers, or combinations thereof. In one aspect, the reinforcement material described herein can be applied together with the fibrous batting such as glass fibers, polymer fibers, or combinations thereof. When applied together, the aerogel can be formed within the fibrous batting. Both the aerogel and the fibrous batting can be then contained in the reinforcement material disclosed herein. for the thermal barrier. In the structural feature 200, the tubes can help to keep the insulating material in place, such as by helping contain aerogel powder. For example, the tubes of the structural feature 200 can be soaked with an aerogel precursor. The precursor can form aerogel subsequently in the tubes according to the process described above. In one aspect, the aerogel formation process can include one or more steps of gelation, aging, and supercritical drying. The tubes can go through the same step during the formation of aerogel from the precursor.

In an example, the tubes may have regular openings. In an example, the tubes may have irregular openings. In an example, the openings can be filled with insulating material during preparation. In an example, the insulating material may comprise aerogel. In an example, the aerogel may comprise reinforce material. In an example, the reinforce material may be fiber glass. In an example, the openings can be lumens. In an example, the openings can allow for air travelling through the structural feature 200 and the thermal barrier. This can help with the air flow in and out of the insulating material during compression of the thermal barrier.

In one example, the cross section of the tubes can be honeycomb shaped to add additional compressibility along the thickness direction of the thermal barrier and the structural feature 200 (e.g., the X-direction). In an aspect, the cross section of the tubes can be polygonal. In an aspect, the cross section of the tubes can be hexagonal, Various shapes of the cross section of the tubes can provide various compressibility to the structural features 200 and corresponding thermal barriers.

In an example, the structural feature 200 can be made of polymers, such as polyimide, polycarbonate, polyester, or combinations thereof. In addition to the shapes of the tube cross sections described above, various materials can further tune the compressibility of the thermal barrier. In one aspect, a material used in the structural feature 200 may melt and carbonize at high temperatures, such as during thermal runaway. In this case, such a carbonized structural feature can still mechanically support the thermal barrier material.

Each of the tubes in the structural feature 200 can be, in one aspect, about 0.1 mm to about 50 mm in diameter (H1). The structural feature 200 may have a thickness (T₁) of about 0.2 mm to about 50 mm. The thickness T₁ can be, in one aspect, about 1 to about 100 times the diameter H₁. A higher thickness T₁ to diameter H₁ ratio provides more compressibility due to the numbers of tubes in the structural feature 200. A lower thickness T₁ to diameter H₁ ratio provides easier processability due to the relatively larger tube diameter H₁, especially during the soaking of the aerogel precursor into the structure feature 200. In some aspects, the thickness T₁ may be about 50 mm while the diameter H₁ may be about 0.5 mm, the thickness T₁ may be about 30 mm while the diameter H₁ may be about 3 mm, the thickness T₁ may be about 15 mm while the diameter H₁ may be about 0.5 mm, the thickness T₁ may be about 10 mm while the diameter H₁ may be about 0.2 mm, the thickness Tⱼ may be about 10 mm while the diameter H₁ may be about 10 mm, the thickness T₁ may be about 5 mm while the diameter H₁ may be about 0.5 mm, or the thickness T₁ may be about 2 mm while the diameter H₁ may be about 0.3 mm.

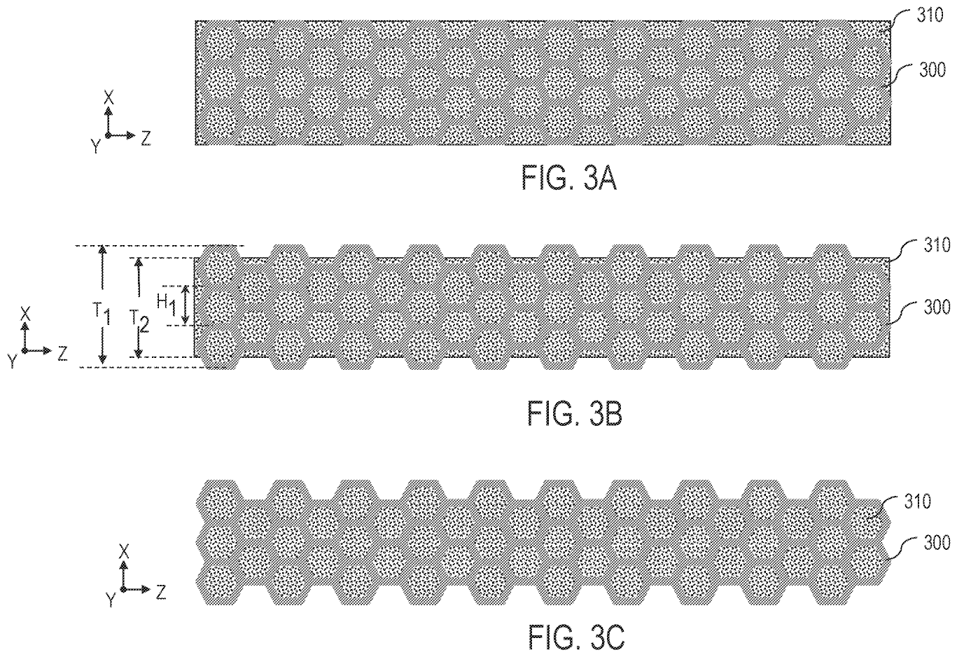

FIGS. 3A-3C depict a thermal barrier including a structural feature 300 and aerogel 310 in an aspect. The aerogel 310 can be aerogel in one aspect, it is correspondingly referred to as aerogel 310 hereafter. However, the aerogel 310 may also be any other suitable insulating material or composition. The structural feature 300 can be like the structural feature 200 discussed above. In the example of FIG. 3A, the structural feature 300 can be contained or embedded within the aerogel 310. The aerogel 310 can form the exterior surface of the thermal barrier. In FIG. 31B, the structural feature 300 can partially extend past the aerogel 310. Both the structural feature 300 and the aerogel 310 can form the exterior of the thermal barrier. In FIG. 3C, the structural feature 300 can enclose the aerogel 310. The structural feature 300 can form the exterior of the thermal barrier.

In an example illustrated in FIG. 3B, exterior faces of the tubes of the structural feature 300 can be outward facing on one or more surfaces of the thermal barrier, such as to allow contact between the tubes and one or more adjacent battery cells. This configuration can help engage the adjacent battery cells and provide additional shear force to prevent the thermal barrier from slipping away from between the adjacent two battery cells and/or allow shear forces to be transferred through the thermal barrier from one adjacent battery cell to another adjacent battery cell.

In some cases, the tubes of the structural feature 300 can be stacked and facing such that one or more concave surfaces faces an external surface of the thermal barrier. In this case, the concave surfaces can potentially be aligned with the edges of the aerogel 310 thermal barrier (FIG. 3A). The aerogel 310 can fill the concave portions and form a flat major surface of the thermal barrier. In some aspects, the methods to manufacture the configuration of FIG. 3A may be less complex (e.g., an easier process) than the methods used to manufacture other configurations, e.g., those shown in FIGS. 3B and 3C. In some cases, the concave surfaces can be misaligned with the edges of the aerogel (FIG. 3D). In some aspects, this configuration may allow for increased shear force to be applied between the structural feature and the adjacent battery cells without substantial damage to the structural feature. In some cases, the concave surfaces can be exposed outside the aerogel 310 (FIG. 3C) In some aspects, this configuration may be effective to contain particulate materials, e.g., dust, that may be produced by the insulation material, e.g., the aerogel 310, within the structural feature 300.

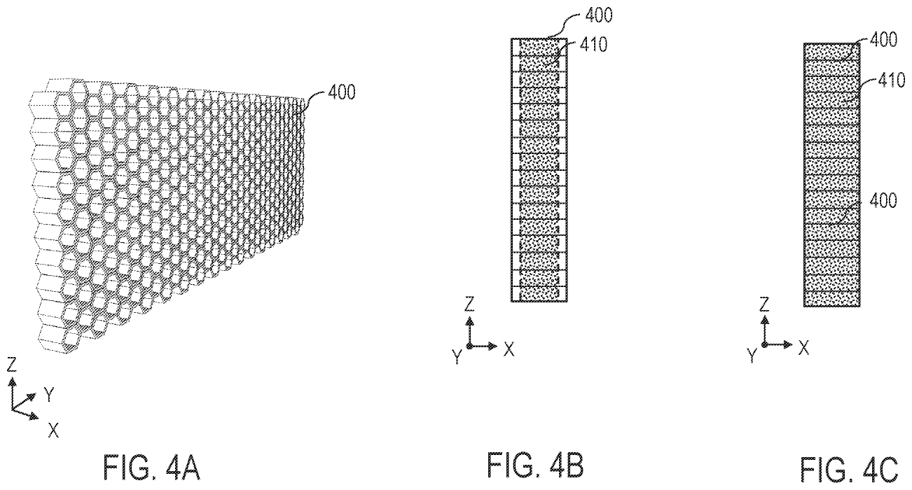

FIGS. 4A-4C depict an example structural feature 400. A perspective view of the structural feature 400 is depicted in FIG. 4A. Side views of the structural feature 400 are depicted in FIGS. 4B and 4C. While the structural features 200 and 300 discussed above include a plurality of tubes, the length (e.g., Y direction) of which can extend across a longer length of the thermal barrier (e.g., Y direction), the length of the tubes in the structural feature 400 (e.g., X direction) go instead across a shorter thickness (e.g., X direction) of the thermal barrier with the insulating material 410. In one aspect, the length of the structural feature 400 tubes can extend orthogonally to the largest surface (e.g., Y-Z plane) of the thermal barrier.

The structural feature 400 can provide increased shear force to adjacent battery cells compared to the configuration described with respect to FIGS. 2A and 2B, where the length of the tubes (Y direction) can run in the major surface (Y-Z plane) of the thermal barrier. This is because the honeycomb cross section of the tubes in configuration of FIG. 4A can provide improved shear force than the peripheral surfaces of the tubes in configuration of FIG. 2A. Additionally, the tubes of the structural feature 400, length of which can extend along the thickness of the thermal barrier, can allow for improved extension properties along the largest surface (in Y-Z plane) of the thermal barrier. The extension of the honeycomb shaped cross section in Y-Z plane (FIG. 4A) can be easier than the extension of the length in Y-Z plane (FIG. 2A). The structural feature 400 can also provide increased pressure to accommodate the expansion of adjacent battery cells during cycling and overall lifetime, compared to the configuration in FIG. 2A. This is because it is harder to compress the tubes along the length direction (X direction) in FIG. 4A than to compress the cross section (in X-Z plane) in FIG. 2A.

In an aspect of the structural feature 400, the tubes can extend along the entire thickness of the thermal barrier as shown in FIG. 4C. In an aspect of structural feature 400, the tubes can extend along a portion of the thickness of the thermal barrier as shown in FIG. 4B. The configuration of FIG. 4C can provide lower thermal conductivity than the configuration of FIG. 4B, because FIG. 4C comprises more insulating material 410 compared to the configuration of FIG. 4B. The configuration of FIG. 4B can be less “dusty” because the insulating material 410, which is usually the source of dust, can be contained within the structural feature 400. The exterior of the thermal barrier, which can contact the adjacent battery cells, can be formed of the structural feature that is less dusty than the insulting material 410 contained therein.

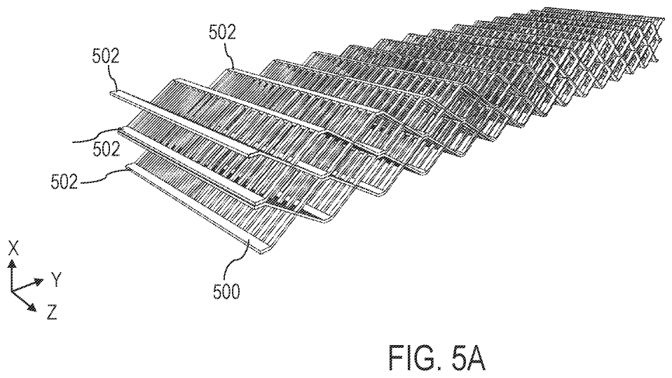

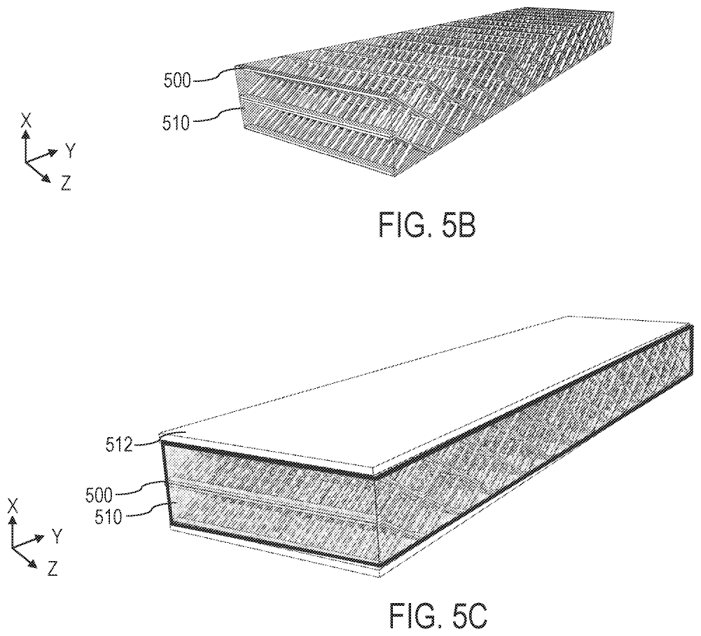

FIGS. 5A-5C depict an example structural feature 500 for use in a thermal barrier with an insulating material 510 and an encapsulation layer 512. The structural feature 500 can include curved plates as shown in FIG. 5A. Each of the curved plates in the structural feature 500 can zig-zag, such as between two horizontal planes (e.g., between parallel Y-Z planes). Insulating material 510 can be formed within the structural feature 500. Encapsulation layer 512 contains articulate materials, e.g., dust, that may be produced by the insulation material, e.g., the insulating material 510 within the structural feature 500.

In some cases, such as shown in FIG. 5A, the curved plates can have one or more parallel strip portions 502 in Y-Z plane, such as aligned with the horizontal (Y-Z) planes.

In one aspect, the structural feature 500 can comprise more than one layer (e.g., 3 in FIG. 5A) of parallel strip portions in planes parallel to the Y-Z plane. The parallel strip portions 502 can serve as footings to support the zig-zag portion of the structural feature 500. The zig-zag portion can provide compressibility in the thickness direction (X direction) of the thermal barrier. The compressibility can accommodate the volume expansion and contraction of the adjacent battery cells during charge and discharge process.

As shown in FIG. 5B, the structural feature 500 can be embedded in an insulating material 510, such as aerogel material described above. The insulating material 510 can form the exterior surface of the thermal barrier.

In some cases, as shown in FIG. 5C, such horizonal planes can be extended to contact each other and therefore form the encapsulation layer 512. Such an encapsulation layer 512 can, in one aspect, be situated over the largest surfaces (in Y-Z plane) of the thermal barrier. In some aspects, the thermal barrier can comprise encapsulation layer 512 over the parallel strip portions 502. The encapsulation layer 512 prevents dust from the insulating material 510.

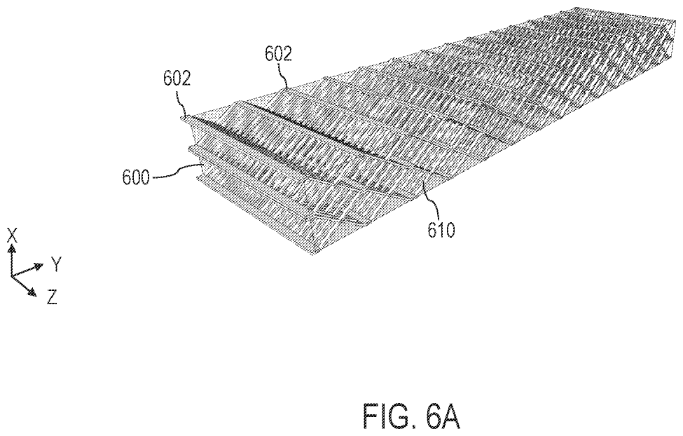

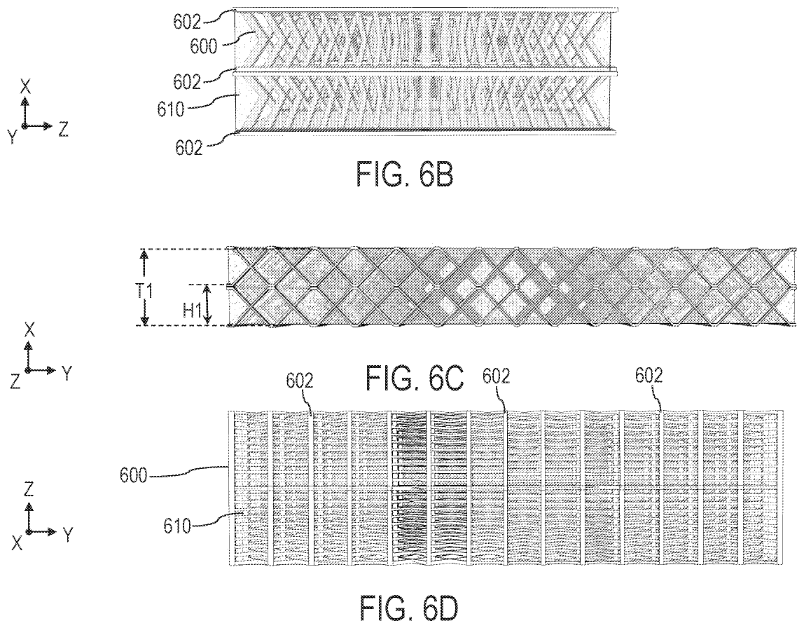

FIGS. 6A-6D depict a structural feature 600 in a thermal barrier with an insulating material 610, such as an aerogel. FIG. 6A illustrates a perspective view, FIGS. 6B and 6C depict side views from Y and Z direction respectively, and FIG. 6D depicts a top view of the structural feature 600 from X direction. Here, the structural feature 600 can be like those described with reference to FIGS. 5A and 5B above and contain one or more curved or zig-zag plates except the outmost parallel strip portions 502 can be exposed to the surface of the thermal barrier for increased shear force. The plates may be situated to provide a lattice structure.

In the aspect of FIGS. 6A to 61), the structural feature 600 can extend beyond the insulating material 610 of the thermal barrier, portions of the structural feature 600, such as strips, angles, or polygonal shapes can extend outward from an external surface of the thermal barrier. In some aspects, the side plane of the structural feature 600 in X-Z plane can be the exposed as the exterior surface of the thermal barrier. In some aspects, the polygonal surface in FIG. 6C of the structural feature 600 can be exposed. In some cases, as shown in FIG. 6D, parallel strips 602 can be used in the structural feature 600. Portions of the parallel strips can extend beyond the insulating material 610 and exposed as an exterior surface of the thermal barrier. The exposed surface of the structural feature 600 can improve the shear force between the thermal barrier and adjacent components, such as battery cells.

In some cases, the structural feature 600 cross sections can include parallelograms. In this case, the corners of the parallelograms can be flattened to connect with adjacent curved plates.

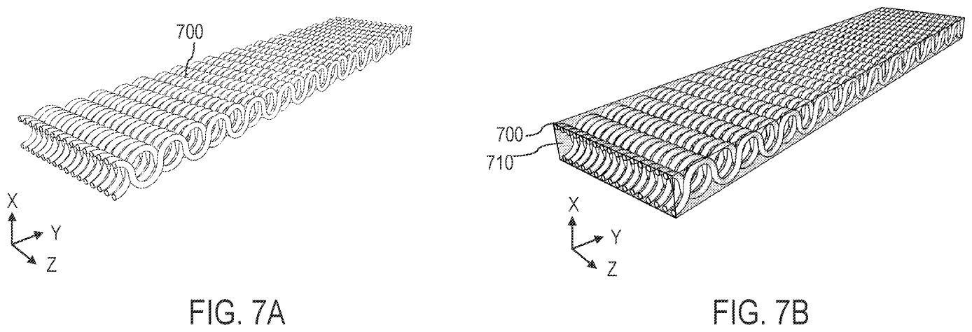

FIGS. 7A-7B illustrate an example thermal barrier structural feature 700 with insulating material 710 (e.g., an aerogel). In the example of FIGS. 7A-7B, the thermal barrier structural feature 700 can include curved cables, such as cables with rounded peaks and valleys. The cables of the thermal barrier structural feature 700 can be situated such that the curvatures extend along a plane (X-Y plane), paralleled each other. In some aspects, the adjacent curved cables in the structural feature 700 can offset each other by half a circle along Y direction. The thermal barrier structural feature 700 can include several curved cables that are symmetrical along a center axis (Y axis). In one aspect, the curved cables can bend like a sine function.

The insulating material 710 can be formed in the thermal barrier structural feature 700. In an aspect where the insulating material is aerogel, the aerogel precursor can be a sol, taken up by the thermal barrier structural feature 700, such as by soaking, painting, brushing, spraying, or other appropriate methods, followed by gelation, aging, and drying. In some cases, the aerogel insulating material 710 can be mixed with additives, such as solution, binder, or other. In some cases, the aerogel insulating material 710 may comprise a reinforcement material, such as a fiber glass reinforcement material or foam reinforcement material. The aerogel insulating material in other aspect structural features discussed herein can be similarly applied.

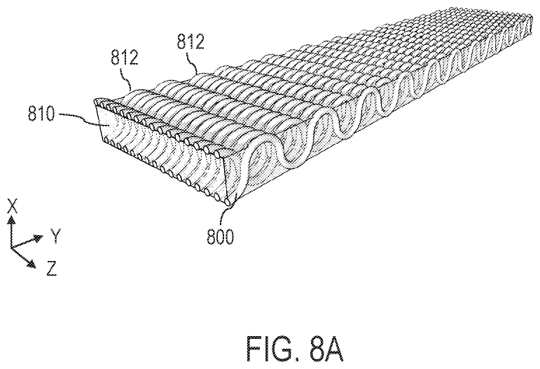

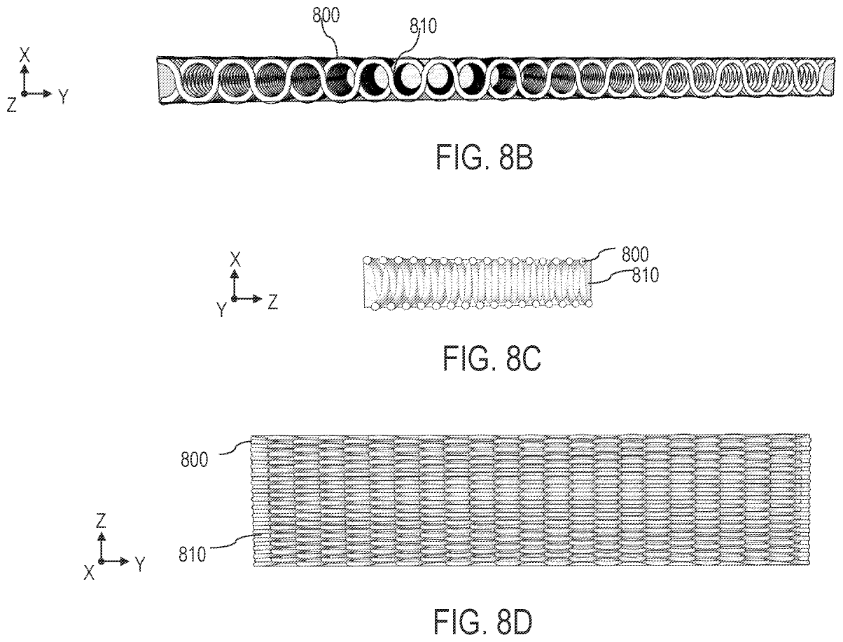

FIGS. 8A-8D illustrate an aspect thermal barrier with a structural feature 800 and insulating materials, such as aerogel 810. In the aspect of FIGS. 8A-8D, the structural feature 800 can be made of cables that curve along the thermal barrier, like those discussed in reference to FIGS. 7A-7B above.

The structural feature 800 can have portions 812 that extend beyond the aerogel 810 at one or more surfaces. In one aspect, extended portions 812 of the structural feature 800 can extend past a surface of the aerogel 810 to impart additional shear force between the thermal barrier and adjacent components of the battery pack, such as battery cells. In an aspect, where the cross-sections are ovals, the tops of the ovals may extend past the aerogel 810.

The structural feature 800 can have cross-sections that are circular, seen in the side view of FIG. 813 along Z direction. These circular cross-sections align such as to form channels through which aerogel 810 can be dispersed. Another side view in FIG. 8C depicts a view down the length of the curved cables along Y direction. FIG. 8D depicts a top-down view of the curved cables aligned with each other along X direction. In some aspects, every other curved cable is offset from each other.

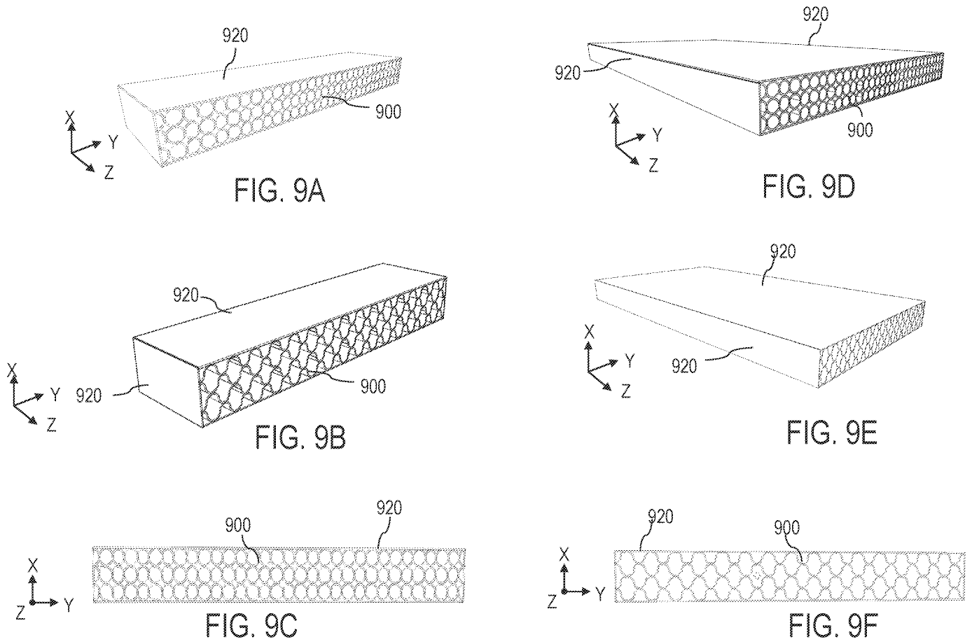

FIGS. 9A-9F illustrate a thermal barrier with a structural feature 900 having encapsulation 920. The structural feature 900 can be made of curved surfaces. The curved surfaces forms tubes along Z direction like those discussed above with reference to FIGS. 8A-8D. FIGS. 9A-9B depict perspective views of the structural feature 900, where the lengths of the tubes (Z direction) can be parallel to one of the shorter edges (Z direction) of the thermal barrier. FIGS. 9D-9E depict perspective views of the structural feature 900, where the lengths of the tubes (Z direction) can be parallel to the longest edge (Z direction) of the thermal barrier. FIGS. 9C and 9F depict side views of the structural feature 900.

One or more sides of the structural feature 900 can be encapsulated, such as by encapsulation 920. In FIGS. 9A-9C, the curved surfaces of the structural feature 900 can extend across a thickness of the thermal barrier. The curved cables can be stacked to form an interconnected multilayered structural feature 900. The stacked curved surfaces can together form one or more channels (or tubes), such as extending along the thermal barrier, either parallel to a shorter edge of the thermal barrier (FIGS. 9A-9C) along Z direction, or parallel to a longer edge of the thermal barrier (FIGS. 9D-9F) along Z direction. Aerogel can be diffused within the channels. These channels can, in one aspect, have circular or oval cross-sections.

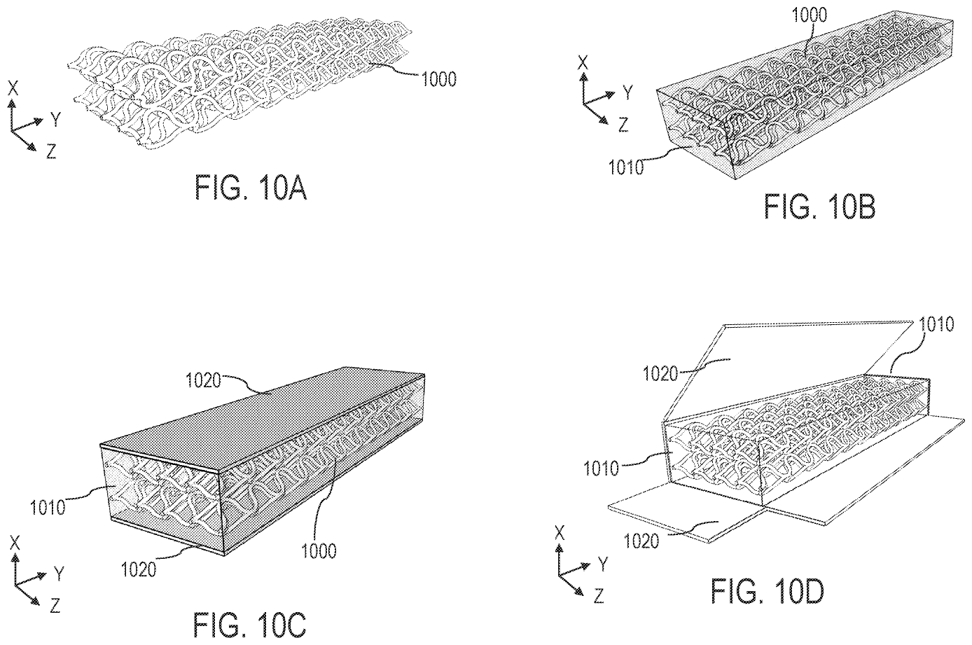

FIGS. 10A-10D illustrate a structural feature 1000 made of a three-dimensional web. The structural feature 1000 can be a cable web that is extendable in three dimensions. An insulating material, such as aerogel 1010, can be within and around the structural feature 1000. An encapsulation 1020 can be used on one or more sides of the structural feature 1000.

In an aspect, the structural feature 1000 cable web can include curved cables. In some cases, the curved cables can be angled relative to a central plane of the thermal barrier. In one aspect, the curved cables can be angled at about 45 degrees relative a central X-Y plane of the thermal barrier. The curved cables within the web can be, in one aspect, mirror images of each other along such a plane. In some cases, the curved cables within the web can be situated parallel to such a plane, such as the cables in FIGS. 7A-8A.

The aerogel 1010 can be formed in the web of the structural feature 1000. In one aspect, the aerogel 1010 can be formed in situ, such as by a sol-gel method and drying process or by a powder formed aerogel. Such an aerogel can be formed in the web by slurry, such as with a binder, solution, and other additives as appropriate.

The aerogel 1010 can be encapsulated by encapsulation 1020 on one or more surfaces of the thermal barrier. In one aspect, two major surfaces facing each other can be encapsulated (FIG. 10C). In an aspect, four surfaces can be encapsulated. In an aspect, all six surfaces can be encapsulated (FIG. 10D).

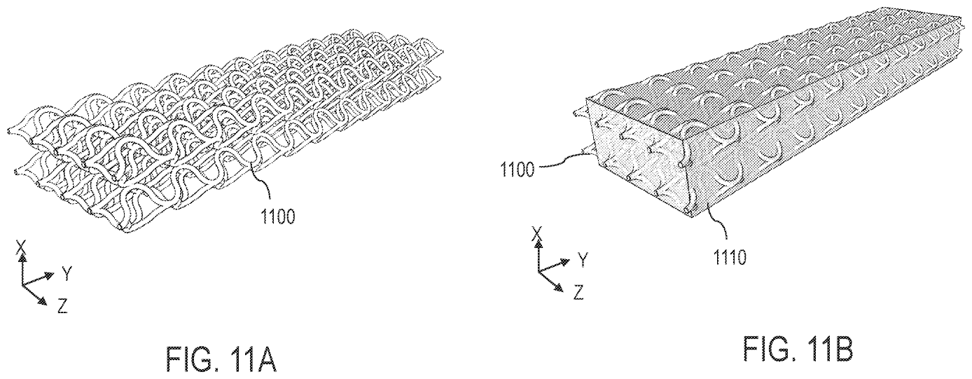

FIGS. 11A-11B illustrate an example structural feature 1100 for a thermal barrier with an insulating material, such as aerogel 1110. In this example, the structural feature 1100 can be a web, such as curved cables, in one aspect like those described with reference to FIGS. 10A-10D above. In the structural feature 1100, the aerogel 1110 can fill or partially fill the structural feature 1100. In one aspect, portions of the structural feature 1100 curved cables, such as peaks of curves, can extend out past the aerogel 1110. The structural feature 1100, with the aerogel 1110 withdrawn from the outermost surfaces of the structural feature 1100 can allow for greater shear force within the thermal barrier, such as greater shear force relative adjacent battery cells or other components.

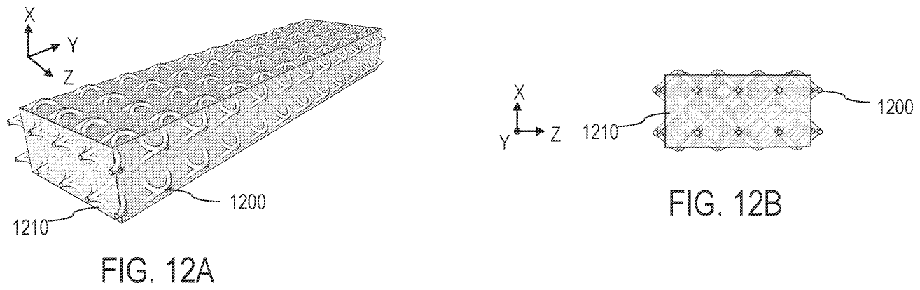

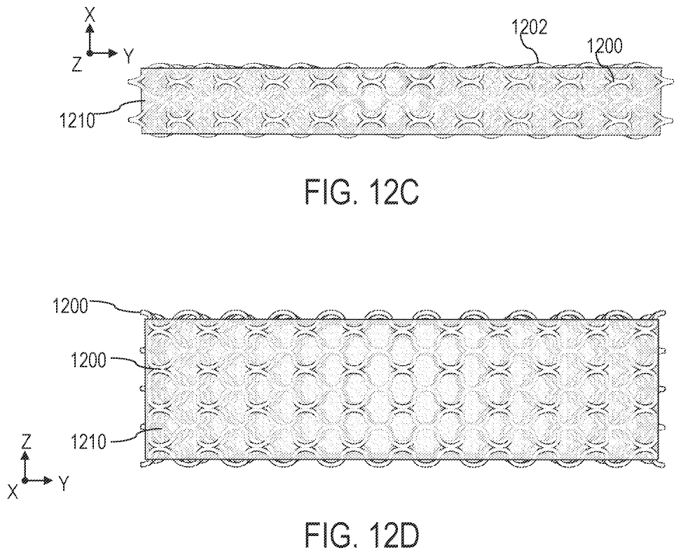

FIGS. 12A-12D illustrate an example structural feature 1200 with aerogel 1210. FIG. 12A depicts a perspective view of the structural feature 1200. FIG. 12D depicts a top-down view along X direction of the structural feature 1200. FIGS. 12B and 12C depict side views of the structural feature 1200 along Y and Z direction respectively. In the views of FIGS. 12C and 12D, the cross-sections of the structural feature 1200 are oval. In the view of FIG. 12B, the cross-sections of the structural feature 1200 are parallelogram shaped. A portion 1202 of the structural feature 1200 is exposed outside of the aerogel 1210.

In some aspects, the structural feature 1200 can be made of fibers of different diameter, length, cross-sectional shape, the same fiber can have different diameters along the length, the diameters may gradually or sharply change along the length of the fiber. The length of the fiber may extend in different directions along the length of the fiber.

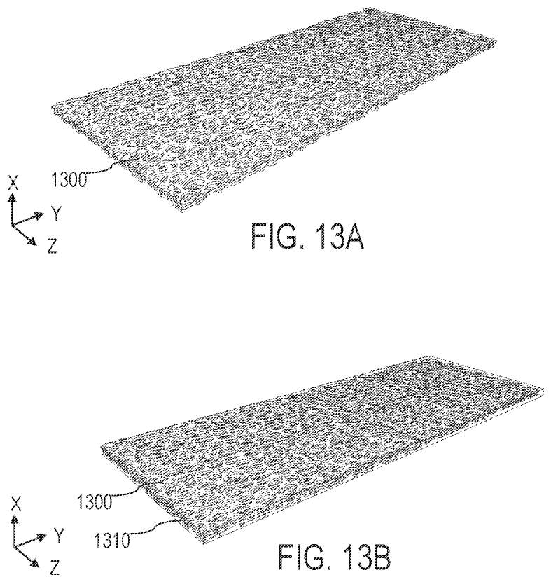

FIGS. 13A-133B illustrate an example structural feature 1300 with an insulating material, such as aerogel 1310. The structural feature 1300 can be a reticulated material, such as a reticulated foam, a reticulated fiber, a reticulated resin, or a reticulated polymer. In this aspect, the structural feature 1300 can be embedded in the aerogel 1310. In one aspect, the reticulated material can include interlacing ribbons or cables irregularly woven together, forming voids between the interlaced ribbons or cables.

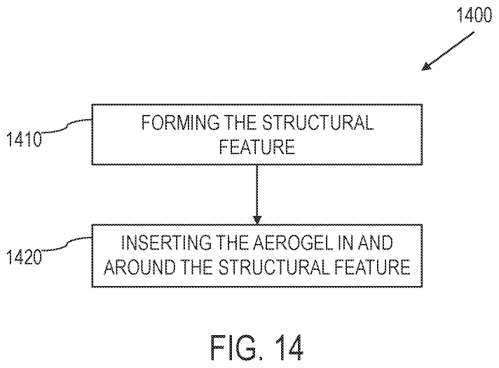

FIG. 14 illustrates a flow chart of a method 1400 of making a thermal barrier. The method 1400 can include forming the structural feature (block 1410) and inserting the aerogel in and around the structural feature (block 1420).

Inserting the aerogel (block 1420) can include in situ formation of the aerogel, such as by application of a sol-gel process and appropriate drying. In some cases, the method can include preparing aerogel powder in slurry. In this case, appropriate binders and additives can be used. Such a sol-gel or aerogel slurry can be inserted in and around an already formed structural feature, or the structural feature can be formed in and around an already formed aerogel.

### Various Notes & Examples

Aspect 1 is a battery module comprising: a stack of battery cells located within a module housing; and a thermal barrier comprising an aerogel between at least two cells in the stack of battery cells, the thermal barrier including an isolation layer having a major plane; and a structural feature distributed in the isolation layer, the structural feature comprising a plurality of elements, each of the plurality of elements extending at least partially through the major plane.

In Aspect 2, the subject matter of Aspect 1 optionally includes wherein the isolation layer comprises an aerogel.

In Aspect 3, the subject matter of any one or more of Aspects 1-2 optionally include the isolation layer comprising a second major plane on a side opposing the first major plane.

In Aspect 4, the subject matter of any one or more of Aspects 1-3 optionally include the isolation layer comprising a thickness extending between the first major plane and the second major plane.

In Aspect 5, the subject matter of Aspect 4 optionally includes wherein the plurality of elements are embedded in the thickness.

In Aspect 6, the subject matter of any one or more of Aspects 4-5 optionally include wherein at least a portion of the plurality of elements extend out of the thickness.

In Aspect 7, the subject matter of any one or more of Aspects 1-6 optionally include wherein the structural feature comprises a plurality of tubes extending along a length of the thermal barrier.

In Aspect 8, the subject matter of Aspect 7 optionally includes wherein the plurality of tubes each comprise a lumen.

In Aspect 9, the subject matter of any one or more of Aspects 7-8 optionally include wherein the plurality of tubes each comprise a hexagonal cross-section.

In Aspect 10, the subject matter of any one or more of Aspects 7-9 optionally include wherein the plurality of tubes each comprise one or more openings through which the aerogel particles can pass.

In Aspect 11, the subject matter of any one or more of Aspects 7-10 optionally include wherein the plurality of tubes each comprise a diameter in a range of about 0.01% to about 100% of a thickness of the structural feature.

In Aspect 12, the subject matter of Aspect 11 optionally includes wherein the structural feature comprises a thickness of about 0.1 mm to about 10 mm.

In Aspect 13, the subject matter of any one or more of Aspects 7-12 optionally include wherein one or more exterior faces of a portion of the plurality of tubes is exposed to an adjacent battery cell.

In Aspect 14, the subject matter of any one or more of Aspects 7-13 optionally include wherein the aerogel covers one or more exterior faces of a portion of the plurality of tubes.

In Aspect 15, the subject matter of any one or more of Aspects 7-14 optionally include wherein the structural feature comprises a plurality of concave surfaces facing one or more adjacent battery cells.

In Aspect 16, the subject matter of Aspect 15 optionally includes wherein the concave surfaces are filled with the aerogel.

In Aspect 17, the subject matter of any one or more of Aspects 7-16 optionally include wherein the thermal barrier comprises a major surface and a minor surface orthogonal to the major surface, the major surface and the minor surface forming a right angle as they meet each other.

In Aspect 18, the subject matter of Aspect 17 optionally includes wherein the plurality of tubes extend parallel to the major surface.

In Aspect 19, the subject matter of any one or more of Aspects 17-18 optionally include wherein the plurality of tubes extend parallel to the minor surface.

In Aspect 20, the subject matter of any one or more of Aspects 1-19 optionally include wherein the structural feature comprises one or more curved plates within the thermal barrier.

In Aspect 21, the subject matter of Aspect 20 optionally includes wherein the structural feature further includes one or more horizontal plates situated on either side of the one or more curved plates.

In Aspect 22, the subject matter of any one or more of Aspects 20-21 optionally include wherein the one or more curved plates are stacked on top of each other within the thermal barrier.

In Aspect 23, the subject matter of any one or more of Aspects 1-22 optionally include wherein the structural feature comprises a lattice structure.

In Aspect 24, the subject matter of any one or more of Aspects 1-23 optionally include wherein the structural feature comprises a crisscross structure.

In Aspect 25, the subject matter of any one or more of Aspects 1-24 optionally include wherein the structural feature comprises one or more portions having a plurality of polygonal cross-sections.

In Aspect 26, the subject matter of any one or more of Aspects 1-25 optionally include wherein the structural feature comprises one or more portions having a plurality of parallelogram cross-sections.

In Aspect 27, the subject matter of any one or more of Aspects 1-26 optionally include wherein the structural feature comprises one or more curved cables.

In Aspect 28, the subject matter of Aspect 27 optionally includes wherein the structural feature comprises one or more curved cables shaped as a sine wave.

In Aspect 29, the subject matter of any one or more of Aspects 27-28 optionally include wherein the one or more curved cables shaped as a sine wave comprises a first curved cable and a second curved cable offset from each other.

In Aspect 30, the subject matter of any one or more of Aspects 27-29 optionally include wherein a portion of the structural feature extends past a surface of the thermal barrier.

In Aspect 31, the subject matter of any one or more of Aspects 27-30 optionally include wherein the structural feature comprises one or more portions having a plurality of circular cross-sections.

In Aspect 32, the subject matter of any one or more of Aspects 27-31 optionally include wherein the structural feature comprises one or more portions having a plurality of oval cross-sections.

In Aspect 33, the subject matter of any one or more of Aspects 27-32 optionally include wherein the structural feature comprises at least two curved cables horizontally stack next to other within the thermal barrier.

In Aspect 34, the subject matter of any one or more of Aspects 27-33 optionally include wherein the structural feature comprises at least two curved cables vertically stacked on each other within the thermal barrier.

In Aspect 35, the subject matter of any one or more of Aspects 1-34 optionally include wherein the structural feature comprises a three-dimensional cable web.

In Aspect 36, the subject matter of Aspect 35 optionally includes wherein the cable web is extendable in three dimensions.

In Aspect 37, the subject matter of any one or more of Aspects 35-36 optionally include wherein the cable web comprises a plurality of curved cables.

In Aspect 38, the subject matter of any one or more of Aspects 35-37 optionally include degrees from a surface of the thermal barrier.

In Aspect 39, the subject matter of any one or more of Aspects 1-38 optionally include wherein the structural feature comprises polyimide, polycarbonate, polyester, or combinations thereof.

In Aspect 40, the subject matter of any one or more of Aspects 1-39 optionally include wherein the aerogel is formed within the structural feature.

In Aspect 41, the subject matter of any one or more of Aspects 1-40 optionally include wherein the aerogel comprises a powder at least partially within the structural feature.

In Aspect 42, the subject matter of any one or more of Aspects 1-41 optionally include wherein the isolation layer comprises a foam at least partially within the structural feature.

In Aspect 43, the subject matter of any one or more of Aspects 1-42 optionally include wherein the aerogel is disposed at least partially within the structural feature.

In Aspect 44, the subject matter of any one or more of Aspects 1-43 optionally include wherein the thermal barrier is encapsulated in one more surfaces.

In Aspect 45, the subject matter of any one or more of Aspects 1-44 optionally include wherein the structural feature is reticulated.

In Aspect 46, the subject matter of any one or more of Aspects 1-45 optionally include wherein the structural feature comprises a reticulated foam.

In Aspect 47, the subject matter of any one or more of Aspects 1-46 optionally include wherein the structural feature comprises a reticulated fiber.

In Aspect 48, the subject matter of any one or more of Aspects 1-47 optionally include wherein the structural feature comprises a reticulated resin.

In Aspect 49, the subject matter of any one or more of Aspects 1-48 optionally include wherein the structural feature comprises a reticulated polymer.

In Aspect 50, the subject matter of any one or more of Aspects 1-49 optionally include a module cover enclosing the stack of battery cells within the module housing.

Aspect 51 is a thermal barrier for use in a battery module, the thermal barrier comprising: an isolation layer configured to thermally isolate individual battery cells within the battery module; and a structural feature distributed within the isolation layer.

In Aspect 52, the subject matter of Aspect 51 optionally includes wherein the structural feature comprises a plurality of tubes extending along a length of the thermal barrier.

In Aspect 53, the subject matter of Aspect 52 optionally includes wherein the plurality of tubes each comprise a hexagonal cross-section.

In Aspect 54, the subject matter of any one or more of Aspects 51-53 optionally include wherein the structural feature comprises one or more curved cables.

In Aspect 55, the subject matter of any one or more of Aspects 51-54 optionally include wherein the structural feature comprises a three-dimensional cable web.

In Aspect 56, the subject matter of any one or more of Aspects 51-55 optionally include wherein the structural feature comprises polyimide, polycarbonate, polyester, or combinations thereof.

Aspect 57 is a method of making a structural feature in a thermal barrier comprising an aerogel, the method comprising: forming the structural feature and inserting the aerogel in and around the structural feature.

In Aspect 58, the subject matter of Aspect 57 optionally includes wherein forming the structural feature comprises heat pressing a structural material together to form a web.

Each of these non-limiting aspects can stand on its own or can be combined in various permutations or combinations with one or more of the other aspects.

The above detailed description includes references to the accompanying drawings, which form a part of the detailed description. The drawings show, by way of illustration, specific embodiments in which the invention can be practiced. These embodiments are also referred to herein as “aspects.” Such aspects can include elements in addition to those shown or described. However, the present inventors also contemplate aspects in which only those elements shown or described are provided. Moreover, the present inventors also contemplate aspects using any combination or permutation of those elements shown or described (or one or more aspects thereof), either with respect to a particular aspect (or one or more aspects thereof), or with respect to other aspects (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A thermal barrier for use in a battery module comprising:
an isolation layer; and
a structural feature distributed in the isolation layer, the structural feature comprising a plurality of elements.

2. The thermal barrier of claim 1, wherein the isolation layer comprises an aerogel.

3. The thermal barrier of claim 1, the isolation layer comprising a first major plane and a second major plane, the first and second major planes on opposing surfaces of the thermal barrier, and a thickness extending between the first major plane and the second major plane.

4. (canceled)

5. The thermal barrier of claim 3, wherein the plurality of elements are embedded in the thickness.

6. The thermal barrier of claim 3, wherein at least a portion of the plurality of elements extend out of the thickness.

7. The thermal barrier of claim 1, wherein the structural feature comprises a plurality of tubes extending along a length of the thermal barrier.

8. (canceled)

9. (canceled)

10. (canceled)

11. (canceled)

12. The thermal barrier of claim 1, wherein the structural feature comprises a thickness of about 0.1 mm to about 10 mm.

13. (canceled)

14. (canceled)

15. (canceled)

16. (canceled)

17. (canceled)

18. The thermal barrier of claim 1, wherein the plurality of elements of the structural feature comprises a plurality of tubes extending parallel to a major surface of the isolation layer.

19. The thermal barrier of claim 1, wherein the plurality of elements of the structural feature comprises a plurality of tubes extending parallel to a minor surface of the isolation layer.

20. The thermal barrier of claim 1, wherein the structural feature comprises one or more curved plates within the isolation layer.

21. The thermal barrier of claim 20, wherein the structural feature further includes one or more horizontal plates situated on either side of the one or more curved plates.

22. (canceled)

23. The thermal barrier of claim 1, wherein the structural feature comprises a lattice structure.

24. (canceled)

25. The thermal barrier of claim 1, wherein the structural feature comprises one or more portions having a plurality of polygonal cross-sections.

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. The thermal barrier of claim 1, wherein the structural feature comprises a reticulated material.

46. (canceled)

47. (canceled)

48. (canceled)

49. (canceled)

50. A battery module comprising:
a stack of battery cells located within a module housing; and
a thermal barrier comprising:
an isolation layer configured to thermally isolate individual battery cells within the stack of battery cells; and
a structural feature distributed within the isolation layer.

51. The battery module of claim 50, wherein the structural feature comprises a plurality of tubes extending along a length of the thermal barrier.

52. (canceled)

53. The battery module of claim 50, wherein the structural feature comprises one or more curved cables.

54. (canceled)

55. (canceled)

56. A method of making a structural feature in a thermal barrier comprising an aerogel composition, the method comprising: forming the structural feature- and forming the aerogel composition in and around the structural feature.

57. The method of claim 56, wherein forming the structural feature comprises heat pressing a structural material together to form a web.
